(19) United States
(12) Patent Application Publication
(10) Pub. No.: US 2013/0179327 A1
(43) Pub. Date: Jul. 11, 2013

(54) ADAPTABLE ASSUMABLE MORTGAGE

(71) Applicant: MORTGAGE MARKET ANALYTICS LLC, New York, NY (US)

(72) Inventors: Brett Young, Califon, NJ (US); Christopher Baltes, Santa Monica, CA (US)

(73) Assignee: MORTGAGE MARKET ANALYTICS LLC, New York, NY (US)

(21) Appl. No.: 13/708,667

(22) Filed: Dec. 7, 2012

Related U.S. Application Data
(60) Provisional application No. 61/569,087, filed on Dec. 9, 2011.

(51) Int. Cl. G06Q 40/02

(52) U.S. Cl. CPC G06Q 40/025
USPC 705/38

(57) ABSTRACT

The present invention relates generally to products, systems and methodologies for providing financing for real estate and more particularly to products and methodologies that provide financing to home owners and home purchasers that are assumable and that are structured so that the mortgages or loans are attractive to both borrowers and/or mortgage lenders/investors. The products, systems and methodologies of the present invention provide assumable mortgages that, either individually or in combination, limit the length of time during which the loan can be assumed and the number of times a loan can be assumed. Other features of the present invention provide for a fee, interest rate adjustment or other compensation to a lender or investor as a result of assumption of a loan. The loan's interest rate can adjust based on the characteristics of the prospective purchaser or assumer of the loan or on the financial characteristics of the transaction itself. The mortgage products and methodologies of the invention are designed with the overall goal of contributing to the stabilization and or strengthening of the residential real estate market and to provide a vehicle to protect and/or enhance the value of a mortgaged property during volatile credit and/or rising interest rate environments.

### RELATED APPLICATION

This application claims priority from U.S. Provisional Patent Application No. 61/569,087, entitled “Adaptable Assumable Mortgage” and filed Dec. 9, 2011, the entirety of which is hereby incorporated by reference herein.

### BACKGROUND OF THE INVENTION

Prior to the 1930's, home financing in the United States was primarily conducted through five (5) year balloon mortgage financing. Under this paradigm, a mortgagor could either pay off the loan after five (5) years or refinance the loan with the mortgagor's lender or financial institution at the prevailing rate. In the late 1920s and 1930s, the housing market suffered severely during the Great Depression as credit availability waned and many borrowers were unable to obtain new loans to refinance their homes. Throughout the 1930s, Congress moved to enact several pieces of legislation designed to bring stable long-term financing and secondary market liquidity to the housing market. This legislation included the creation of the Federal Home Loan Banks System and Fannie Mae, and was largely successful in bringing about a stable system where longer term financing, through fifteen (15) to thirty (30) year mortgages, became the foundation for American home financing.

With the introduction and increase in popularity of longer term financing, a feature of mortgages whereby repayment of the principal balance was accelerated upon sale of the underlying real estate asset was subjected to more scrutiny. The so-called Due-On-Sale clause that had historically been intermittently incorporated into mortgage contracts, became a popular feature of mortgages and sporadically the subject of much regulatory and judicial attention. After a series of state and federal judicial decisions, including a ruling from the United States Supreme Court in the 1980s, the issue of enforceability of Due-On-Sale clauses was settled in favor of allowing enforcement under Federal banking law. Because of the harsh and expensive downside of acceleration resulting from Due-On-Sale provisions, the legal paradigm had the practical effect of rendering all mortgage contracts with Due-On-Sale clauses non-assumable, except under narrowed circumstances that were provided for by statute. This series of rulings, coupled with a sustained period of rising interest rates, led non-government agency lenders and government sponsored enterprises to virtually eliminate long term fixed rate assumable mortgages from their offerings.

The evolution and growth of the mortgage-backed securities (“MBS”) market as the primary venue for the financing of residential mortgages has also contributed to the dramatically decreased availability of assumable mortgages. Investors in mortgage-backed securities invest on the basis of an estimated time horizon within which they expect a real estate asset to be sold or refinanced. In a rising interest rate environment, lenders and investors in mortgage-backed securities prefer to be repaid sooner rather than later so that they can relend or reinvest the funds at a higher interest rate. As the sale of a real estate asset that was secured with an assumable mortgage might not result in repayment of the original loan, an assumable mortgage renders the repayment time horizon less predictable and also reestablishes the opportunity for the loan horizon to run for the life of the contract term. Accordingly, investors do not consider assumable mortgages, as they are currently structured, to be an attractive investment.

If all other aspects of a mortgage are equal, borrowers will always benefit, and therefore prefer, an assumable mortgage over a similar featured non-assumable loan. This is because in a rising interest rate environment, the lower affixed financing cost makes the underlying housing asset more valuable and properties with assumable mortgages are more likely to sell, sell quicker, and most importantly, sell at a higher price. Further, assumable mortgages are beneficial to the broader economy. Wide scale use of assumable mortgages would remove or invert the negative dynamic of rising interest rates on mortgaged property, would embed low long term interest rates into the real estate economy, would allow for higher cure rates on non-performing loans, and would increase the frequency of transactions in the real estate market which in turn would benefit realtors, builders, contractors, and ancillary service providers. However, as discussed above, in certain interest rate environments, the risk of an uncertain or less predictable repayment time horizon and an inability to relend capital at higher interest rates, makes assumable mortgages, as they are currently structured, unattractive to lenders and investors. This risk of an uncertain repayment time horizon is referred to as extension risk or duration risk in the mortgage-backed securities market.

It would therefore be an improvement on the prior art to provide a methodology of financing for real property that provides an assumable mortgage that is attractive to both borrowers and investors whereby borrowers receive the benefits of assumable mortgages but lenders exposure to extension risk has been mitigated and/or compensated for.

### SUMMARY OF THE INVENTION

As they currently exist, all assumable mortgages have the following features: they are assumable for the entire term of the loan, they are assumable an unlimited number of times during the life of the loan, and they do not allow adjustments to their interest rate based on the characteristics of the prospective purchaser/assumer. Because of these features, there are many interest rate environments in which assumable mortgages are not attractive to lenders and investors, such as MBS investors. The products, systems and methodologies of the present invention provide a series of features for assumable mortgages that, either individually or in combination, create assumable mortgages with the following characteristics: (1) there is a limit to the length of time during which the loan can be assumed, (2) there is a limit to the number of times a loan can be assumed, (3) the lender or investor receives a fee upon each assumption event, (4) the loan's interest rate can adjust based on market conditions upon each assumption, (5) the loan's interest rate can adjust based on the characteristics of the prospective purchaser/assumer upon each assumption, (6) and the loan's interest rate can adjust based on the financial characteristics of the transaction itself upon each assumption.

The mortgages of the invention, and the methods and systems related to the same, can take a variety of forms to accomplish the intended purpose. The methodologies, systems and mortgage products of the invention for mitigating and/or compensating for extension risk can comprise (a) maintaining an original real estate financing contract with an existing borrower, which contract is for a loan for a principal amount and secured by a mortgage on residential real estate held by the first borrower, (b) providing in the contract for the assumption of the loan by a subsequent borrower, (c) providing in the contract for a fee that is due as a result of said assumption, and (d) wherein said fee is intended to compensate for perceived extension risk associated with the assumption. The inventions hereunder can be assumable a defined number of times or only during a specified period of time.

Also contemplated by the invention are systems, methods and products for mitigating and/or compensating for extension risk associated with a real estate mortgage comprising (a) maintaining an original real estate financing contract with an existing borrower, which contract is for a loan for a principal amount and secured by a mortgage on residential real estate held by the first borrower, (b) providing a contract for the assumption of the loan by a subsequent borrower, (c) engaging in a transaction wherein the subsequent borrower assumes the responsibilities of the existing borrower for said real estate financing contract, (d) imposing a fee as a result of the transaction, and (e) wherein said fee is intended to compensate for perceived extension risk associated with the assumption. The methods, systems and products of the invention can provide for mortgages that are assumable a defined number of times or only during a specified period of time.

The inventive methods, systems and products also provide for mortgages where the investor is compensated through interest rate adjustments. For example, the invention provides systems, methods and mortgage products for mitigating and/or compensating for extension risk comprising (a) maintaining an original real estate financing contract with an existing borrower, which contract specifies a first interest rate for a loan for a principal amount that is secured by a mortgage on residential real estate held by the existing borrower, (b) providing a contract for the assumability of the loan by a subsequent borrower, (c) providing a contract for a different interest rate as a result of said assumption; and (d) said different interest rate intended to compensate for perceived extension risk associated with the assumption. The adjusted interest rate can be within a range of a defined number and the range can be within one percentage point of an interest rate specified in the contract or some other specified rate. The mortgage product can be made assumable one time or during a specified period of time.

In other embodiments, the systems, methods and mortgage products of the invention provide for mitigating and/or compensating for extension risk comprising (a) maintaining an original real estate financing contract with an existing borrower, which contract is for a loan for a principal amount and secured by a mortgage on residential real estate held by the first borrower, (b) providing a contract for the assumption of the loan by a subsequent borrower, and (c) wherein said contract is assumable during a specified period of time.

The systems, methods and mortgage products can also comprise (a) maintaining an original real estate financing contract with an existing borrower, which contract is for a loan for a principal amount and secured by a mortgage on residential real estate held by the first borrower, (b) providing a contract for the assumption of the loan by a subsequent borrower, and (c) wherein said contract is assumable a defined number of times. The mortgage products of the inventions can be securitized, wrapped or insured.

### BRIEF DESCRIPTION OF THE DRAWINGS

The accompanying drawings incorporated in and forming a part of the specification illustrate several aspects of the present invention, and together with the description and claims serve to explain the principles of the invention. In the drawings:

FIG. 1 is a flow chart showing an embodiment of the mortgage product of the invention wherein the mortgage is assumable only two times.

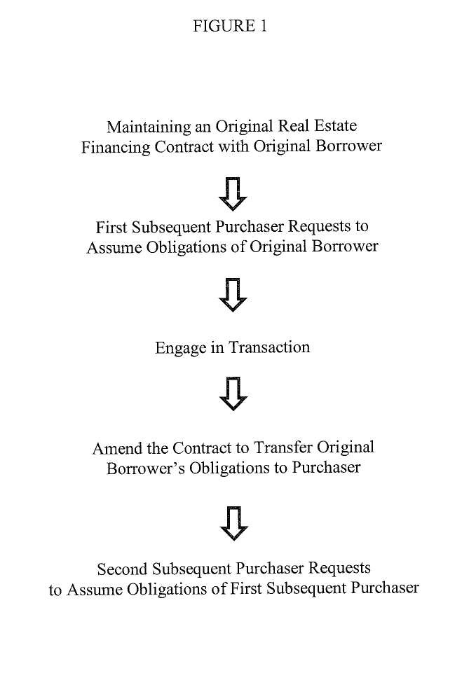

FIG. 2 is a flow chart showing an embodiment of the mortgage product of the invention wherein the mortgage is assumable only one times and a fee is assessed to compensate an investor.

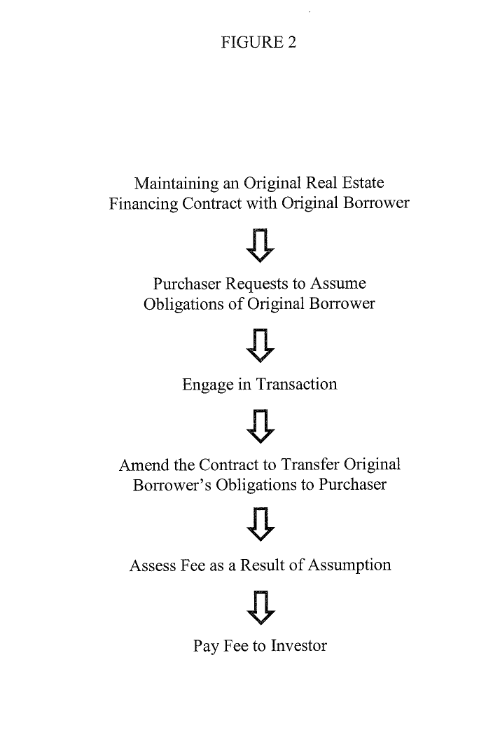

FIG. 3 is a flow chart showing an embodiment of the mortgage product of the invention wherein the mortgage is assumable and the interest rate is adjusted to compensate an investor.

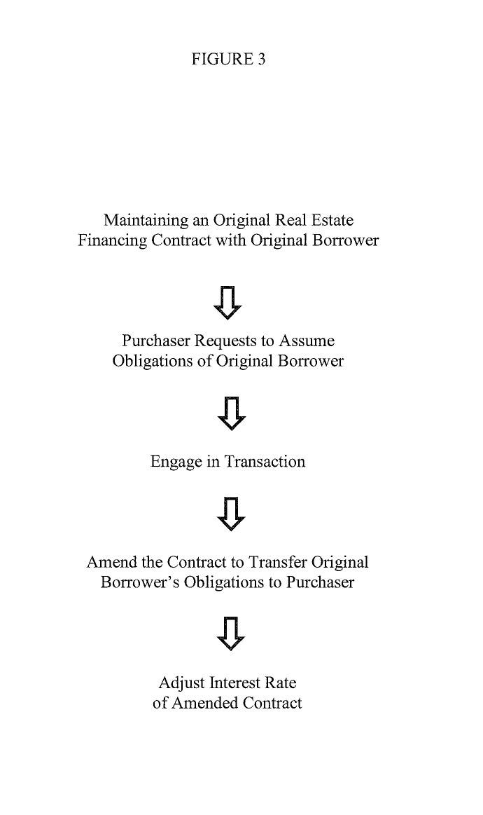

FIG. 4 is a flow chart showing an embodiment of the mortgage product and methodology of the invention wherein the mortgage is assumable and the interest rate of the amended contract is adjusted to get a new base rate, the base rate is further adjusted consistent with an LLPA, and the base rate is even further adjusted for a fee due upon assumption in the form of an interest rate increase as opposed to a one-time fee.

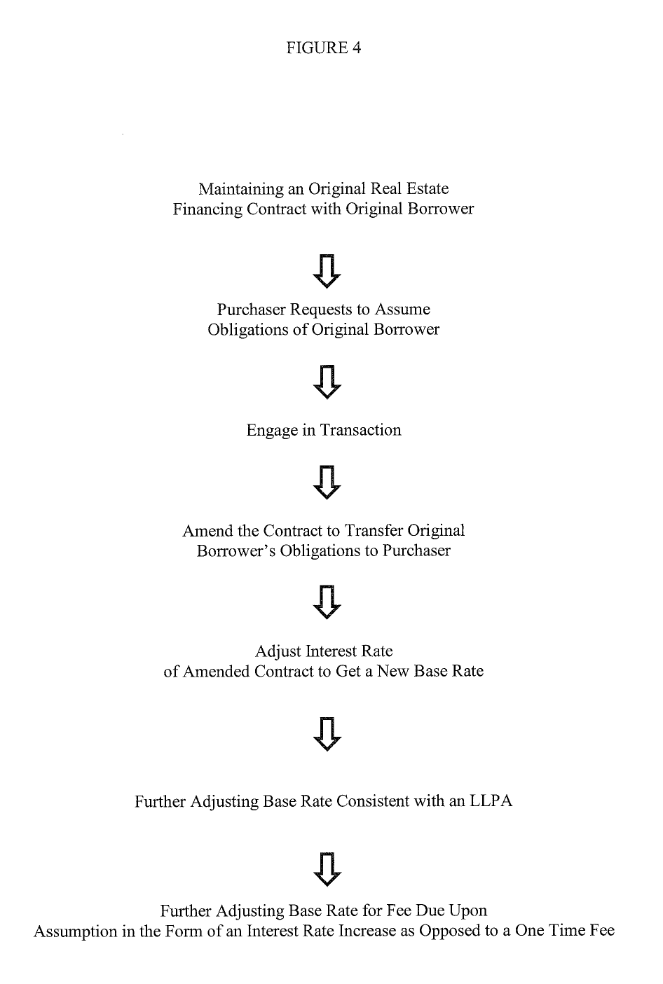

### DETAILED DESCRIPTION OF THE INVENTION

Reference will now be made in detail to the invention, examples of which are illustrated in the accompanying drawings. The invention described herein provides systems, methods and products that advantageously permit a relatively flexible and convenient real estate financing agreement or mortgage for a borrower seeking to have the ability to transfer the obligations in an existing real estate financing contract while at the same time reducing a lender's or an investor's extension risk and or compensating the lender or investor for that risk. For purposes of the invention herein, an investor includes any individual or entity that invests in a debt, note, mortgage security or other similar obligation, or a holder or an owner of the same and can also include a bank or other financial institution or firm that holds, owns, or invests in the same. The invention contemplates any kind of instrument, including but not limited to, real estate financing contracts, mortgages, promissory notes, indentures, and other promises to repay any financial obligation.

In some embodiments of the invention, an existing borrower transfers its obligations to make payments on a debt secured by a real estate asset, to a prospective borrower. A prospective borrower or purchaser, who is the prospective assumer or assumer for purposes of the inventions described herein, of a real estate asset assumes the obligations to make payments on a debt secured by a real estate asset from an existing borrower. In particular embodiments, the systems, methodologies and products of the invention provide for compensation to a lender or investor as a result of transfer or assumption of the existing borrower's obligations. In some embodiments, the lender or investor is compensated for the perceived risk associated with the transfer or assumption of the existing borrower's obligations. In other embodiments of the invention, the terms and balance of an existing real estate financing contract or mortgage are conveyed or transferred to a prospective purchaser of a previously financed property. In other embodiments of the invention, the transfer to or assumption of the obligations of an existing real estate financing contract or mortgage by a prospective purchaser or borrower obviates the need for the prospective purchaser to obtain new financing or other new funding for the real estate asset.

It is to be appreciated that the present teachings contemplate products and methodologies that provide for the transfer or assumption of the financial obligations associated with a real estate financing contract. In certain embodiments, the transfer or assumption is coupled with a fee levied or otherwise assessed as a result of the transfer or assumption in order to compensate investors or other entities for any perceived economic risk associated with the transfer. The methods and products may include charging a fee or an increased interest rate on both fixed and adjustable mortgages and other residential loans. The methods and products of the present invention avoid the problems of the prior art by providing an assumable real estate financing contract that is suitable or attractive to investors and borrowers. It is contemplated by the inventions herein that the fee assessed as a result of assumption or the adjustment to the interest rate as a result of assumption can be at any time before, contemporaneous with or subsequent to the assumption.

The flexibility with which an existing borrower may transfer or a prospective borrower may assume the obligations on a real estate financing contract, note, or other debt can be limited or unlimited. In one embodiment, the financial obligation of the existing borrower is transferable or assumable for only a specified number of times during the term of the contract. In another embodiment, the specified number of times is only once, or at most once, or at most twice, or at most three times, or at most four times, or at most five times, or at most six times, or at most seven times, or at most eight times, or at most nine times, or at most ten times, or at most eleven times, or at most twelve times, or at most thirteen times, or at most fourteen times, or at most fifteen times, or at most sixteen times, or at most seventeen times, or at most eighteen times, or at most nineteen times, or at most twenty times, or at most a number between twenty-one times to thirty times, or can be at most a number between thirty-times to an unlimited number of times.

In another embodiment of the invention, the obligation of an existing borrower is transferable or assumable for a specified period of time during the term of the real estate financing contract, note or other debt instrument. In another embodiment, the specified period in which the borrower may transfer its obligation is at a point in time between the effective date of the contract, mortgage, note, instrument or financial obligation and six months thereafter. In another embodiment, the specified period is a point in time between the effective date and one year thereafter, or two years thereafter, or three years thereafter, or four years thereafter, or five years thereafter, or six years thereafter, or seven years thereafter, or eight years thereafter, or nine years thereafter, or ten years thereafter, or eleven years thereafter, or twelve years thereafter, or thirteen years thereafter, or fourteen years thereafter, or fifteen years thereafter, or sixteen years thereafter, or seventeen years thereafter, or eighteen years thereafter, or nineteen years thereafter, or twenty years thereafter, or twenty-one years thereafter, or twenty-two years thereafter, or twenty-three years thereafter, or twenty-four years thereafter, or twenty-five years thereafter, or twenty-six years thereafter, or twenty-seven years thereafter, or twenty-eight years thereafter, or twenty-nine years thereafter, or thirty years thereafter, or thirty to thirty-five years thereafter, or thirty-five to forty years thereafter, or forty to forty-five years thereafter, or forty-five to fifty years thereafter. The specified period of time can be any number of days, any number of weeks and any number of years.

In yet other embodiments the specified period of time during which the real estate financing contract, mortgage, note or other debt instrument may be assumed or transferred is only during the first year, only during the second year, only during the third year, only during the fourth year, only during the fifth year, only during the sixth year, only during the seventh year, only during the eighth year, only during the ninth year, only during the tenth year, at least during the eleventh year, only during the twelfth year, only during the thirteenth year, only during the fourteenth year, only during the fifteenth year, only during the sixteenth year, only during the seventeenth year, only during the eighteenth year, only during the nineteenth year, only during the twentieth year, only during the twenty-first year, only during the twenty-second year, only during the twenty-third year, only during the twenty-fourth year, only during the twenty-fifth year, only during the twenty-sixth year, only during the twenty-seventh year, only during the twenty-eighth year, only during the twenty-ninth year, or only during the thirtieth year of the term of the contract. In yet other embodiments of the invention, the specified period of time is only during the thirtieth to the fiftieth year of the term of the contract. In other embodiments, the specified period of time is any combination of time periods, for example, any range of days, any range of weeks, any range of months or any range of years during the term of the contract.

In another embodiment of the invention, the interest rate paid by the purchaser or assumer upon assumption of the obligations of the real estate financing contract, mortgage or debt instrument is adjusted to be within a specified range. In another embodiment, the interest rate paid by the purchaser or assumer is adjusted to be within one quarter, one half, three quarters, one, one and one quarter, one and one half, one and three quarters, two, two and one quarter, two and one half, two and three quarters, three, three and one quarter, three and one half, three and three quarters, four, four and one quarter, four and one half, four and three quarters, five, six, seven, eight, nine, ten, eleven, twelve, thirteen, fourteen, fifteen, sixteen, seventeen, eighteen, nineteen, or twenty, or any fraction thereof, of a specified number or of a number determined by the parties to an existing contract, a third party, a financial market, a national government, or some other rate that one of skill in the art would deem appropriate. In other embodiments of the invention, the interest rate paid by the purchaser or assumer is adjusted to be within zero to five, five to ten, ten to fifteen, fifteen to twenty, twenty to twenty-five, twenty-five to thirty, thirty to thirty-five, thirty-five to forty, forty to forty-five, forty-five to fifty, or fifty to one hundred percentage points, or any fraction thereof, of a specified number or of a number determined by the parties to an existing contract, a third party, a financial market, a national government, or some other rate that one of skill in the art would deem appropriate. Determination of the interest rates herein pursuant to any amendments to the real estate financing contracts may be made according to a predetermined formula, it may be determined with regard to an economic indicator index, an established interest rate (e.g., prime rate), according to established interest rate indices or the like.

The products and methodology of the invention can be any combination of the foregoing. In some embodiments, the mortgage or debt instrument is assumable a specified number of times as set forth herein but only for a limited period of time. For example, in one embodiment, the mortgage or debt instrument is assumable only one time and only during the first year of the term of the loan. Any combination is envisioned and one of skill in the art would be able to determine the various possibilities. In some embodiments, the mortgage or debt instrument is assumable one time, or at most once, or at most twice, or at most three times, or at most four times, or at most five times, or at most six times, or at most seven times, or at most eight times, or at most nine times, or at most ten times, or at most eleven to fifteen times, or at most sixteen to twenty times, or at most twenty-one times to thirty times and only during the first year from the effective date, or up to the second year from the effective date, or up to the third year from the effective date, or up to the fourth year from the effective date, or up to the fifth year from the effective date, or up to the sixth year from the effective date, or up to the seventh year from the effective date, or up to the eighth year from the effective date, or up to the ninth year from the effective date, or up to the tenth year from the effective date, or up to the eleventh year from the effective date, or up to the twelfth year from the effective date, or up to the thirteenth year from the effective date, or up to the fourteenth year from the effective date, or for some other specified time limit. One of skill in the art would be able to determine the combination of the foregoing that would be appropriate in any proposed contract.

In yet other embodiments of the invention, the mortgage or debt instrument is assumable a specified number of times and for a limited period of time as disclosed herein, and the interest rate paid by the purchaser on assumption of the obligations of the real estate financing contract or debt is within a specified range as disclosed herein. For example, in one embodiment, the mortgage is assumable only once and only during the first year of the term and the interest rate paid by the purchaser on assumption is adjusted to be within one half of one percent of the Cost of Funds Index (COFI). Any combination of frequency, term limits and interest rates is envisioned by the invention and one of skill in the art would be able to determine the various combinations that are available.

It is also contemplated that in some embodiments of the invention, a provision or restriction is added or becomes effective at a specified time or after a specified period of time—for example, after the specified number of assumptions and/or after the specified period of time—that accelerates the principal debt that would be owed upon a subsequent sale or other event affecting the ownership rights of the property, e.g., a due-on-sale clause. In some embodiments, the mortgage or financing instrument is assumable a specified number of times as disclosed herein, and the mortgage or debt instrument is amended after the specified number of assumptions has occurred to include a due-on-sale provision. In other embodiments, the mortgage or financing instrument is assumable a specified number of times as disclosed herein, and after the specified number of assumptions has occurred, a due-on-sale provision that was pre-existing in the mortgage or debt instrument becomes effective or operative. In other embodiments, the mortgage or debt instrument is assumable for a limited amount of time as disclosed herein, and the mortgage or debt instrument is amended after the specified number of assumptions has occurred and/or the specified period of time has passed to include a due-on-sale provision. In other embodiments, the mortgage or debt instrument is assumable for a limited amount of time as disclosed herein, and at or near the end of the specified period of time, a due-on-sale provision that was pre-existing in the mortgage or debt instrument becomes effective or operative. In yet other embodiments, the mortgage or debt instrument is assumable and the interest rate paid by the purchaser on assumption of the obligations of the real estate financing contract or debt is adjusted to be within a specified range, and the mortgage or financing contract is amended to change the interest rate. In other embodiments, the mortgage or debt instrument is assumable and the interest rate paid by the purchaser on assumption of the obligations of the real estate financing contract or debt is adjusted to be within a specified range and the mortgage or financing contract is amended to change the interest rate. In yet other embodiments, the mortgage or debt instrument is assumable a specified number of times and for a limited period of time as disclosed herein, and after the specified number of assumptions has occurred and/or after the specified period of time has passed, the mortgage or debt instrument is amended to include a due-on-sale provision. In other embodiments, the mortgage or debt instrument is assumable a specified number of times and for a limited period of time as disclosed herein, and after the specified number of assumptions has occurred and/or after the specified period of time has passed, a due-on-sale provision that was pre-existing in the mortgage or debt instrument becomes effective or operative. In yet other embodiments, the mortgage or debt instrument is assumable for a specified number of times and only during a limited period of time as disclosed herein and the interest rate paid by the purchaser on assumption of the obligations of the real estate financing contract or debt is adjusted to be within a specified range, and after the specified number of assumptions has occurred and/or after the specified period of time has passed, the mortgage or debt instrument is amended to include a due-on-sale provision and/or the mortgage or financing contract is amended to change the interest rate. In other embodiments, the mortgage or debt instrument is assumable a specified number of times and only during a limited period of time as disclosed herein and the interest rate paid by the purchaser on assumption of the obligations of the real estate financing contract or debt is adjusted to be within a specified range, and after the specified number of assumptions has occurred and/or after the specified period of time has passed, a due-on-sale provision that was pre-existing in the mortgage or debt instrument becomes effective or operative and/or the mortgage or financing contract is amended to change the interest rate.

The methodology of the invention enables an existing borrower to transfer any financial obligation to another party. The type of financial obligation that may be transferred or assumed is not limited to a real estate financing contract, but may include any type of debt obligation or promissory note. Though generally the real estate financing transactions contemplated herein will be first mortgages on a borrower's primary residence, they need not be. Other financing transactions are also within the scope, such as encumbrances on properties that are junior liens to first mortgages, such as home equity loans and fixed rate second and third mortgages. In other embodiments, the financial obligation that is transferable is that of a home equity line of credit. In another embodiment, the financial obligation is a first or primary mortgage. In another embodiment, the financial obligation is a second, or a third or a fourth mortgage. In other embodiments, the financial obligation, note or debt is secured by real estate. In yet other embodiments of the invention, the financial obligation is unsecured.

The present invention can be implemented with a computer apparatus or data processing system. The computer apparatus or data processing system can be used to implement or assist with primary or original origination, primary or original underwriting, subsequent origination upon an assumption, subsequent underwriting upon an assumption, servicing, securitizing and reporting the mortgage products and methodologies of the invention. The origination, underwriting, servicing, securitization, and reporting processes are well-known in the art and one of skill in the art would be familiar with methods and processes required to provide mortgage products according to the present invention. The computer apparatus or data processing system according to the invention comprises a memory circuit for storage of data, the memory circuit containing a quantity of random access memory and a bulk memory storage device; a processing circuit that is configured to manipulate data in the memory circuit. In some embodiments, the memory circuit receives as input data various parameters associated with the purchase, such as characteristics of the prospective purchaser; the amount representing a sale price of a real estate property to be sold to a prospective purchaser; a down payment amount; or an appraisal value of the real estate property. The characteristics of the prospective purchaser include work history, creditworthiness, borrowing and repaying history relative to other debt obligations, criminal history or other criteria that one of skill in the art would consider when determining whether to extend credit or a loan to a purchaser.

Still in accordance with another aspect of the present invention, a computer apparatus or data processing system can be used to implement or assist with primary or original origination, primary or original underwriting, subsequent origination upon an assumption, subsequent underwriting upon an assumption, servicing, securitizing, and reporting of the financial obligations according to the invention is provided, which comprises a memory circuit for storage of data, the memory circuit containing a quantity of random access memory and a bulk memory storage device; a processing circuit that is configured to manipulate data in the memory circuit. In some embodiments, the memory circuit receives as input data various parameters associated with the purchase, such as characteristics of the prospective purchaser and/or assumer; the amount representing a sale price of a real estate property to be sold to a prospective purchaser; a down payment amount; or an appraisal value of the real estate property. The characteristics of the prospective purchaser include work history, creditworthiness, borrowing and repayment history relative to other debt obligations, criminal history or other criteria that one of skill in the art would consider when determining whether to extend credit or a loan to a purchaser and at what interest rate at which the loan is made.

The systems, methodologies and products of the invention can incorporate a predetermined or ad hoc set of guidelines or standards. For example, in some embodiments, the obligations of the existing borrower are not transferable to a new borrower unless the new borrower qualifies under the guidelines set by a lender or guarantor.

The systems, methodologies and products of the invention include the ability to flexibly price the product to the consumer. In some embodiments, there is a pricing differential between long term fixed rate assumable mortgages and similar loans without assumption features. In one embodiment, the base or published rate for comparable non-assumable mortgages includes the net effect of pricing adjustments based upon the characteristics of the prospective purchaser including work history, creditworthiness, borrowing and repayment history relative to other debt obligations, criminal history or other criteria that one of skill in the art would consider when determining whether to extend credit or a loan to a purchaser and at what interest rate at which the loan is made. In other embodiments, the rate includes a fee or other premium which will be used to compensate investors for the perceived extension risk associated with the transfer or assumption. In other embodiments, the assumability fee structure is available in a matrix or table format to allow the consumer to see the pricing impact of various combinations of the products of the invention. In other embodiments, the borrower will be able to choose to structure the fee as a one-time fee at closing or as an increase in the interest rate.

The systems, methodologies and products of the invention can employ any method or process for underwriting or otherwise assessing the eligibility of a borrower to qualify for a loan, promissory note, indenture, or other product. In one embodiment, the invention uses the same qualifying criteria as conventional conforming long term fixed rate loans, promissory notes, indentures or other products. In another embodiment, the invention uses qualifying criteria for non-assumable short term fixed rate loans. In yet other embodiments, the invention uses variable rates. In yet other embodiments of the invention, the methodology of the invention uses a computerized, digital or other electronic platform or method to underwrite the loan, promissory note, indenture or other product. The underwriting platform, system or method can use any number of a variety of adjustments. In one embodiment, the underwriting platform or method will have the same pricing adjustments as established adjustments or standards set by a third party.

The invention can employ any form of servicing in order to collect the timely payment of fees, expenses, interest and other items from the borrowers. The level of service can vary depending on the type of loan, promissory note, indenture or other product. Servicers can be compensated in a variety of ways, including through percentages taken of the unpaid balance on the loans they service or paid as a set fee per loan. In some embodiments, the rate at which the servicer is compensated depends upon the type of real estate which the loan, promissory note, indenture or other product secures and the level of service required.

In certain embodiments, the invention provides for a real estate financing contract, debt or other note that is freely transferable. In other embodiments, the invention provides for a real estate financing contract, debt or other note that precludes transferability except upon the satisfaction of certain condition. For example, in some embodiments, the real estate financing contract, debt or other note is transferable or assumable in the event that the prospective borrower, assumer or purchaser satisfies lending guidelines, standards or other creditworthiness standards. In other embodiments, the real estate financing contract, debt or other note is transferable or assumable in the event that other property or appraisal related items satisfy servicing, origination or other underwriting standards. In yet other embodiments, the real estate financing contract, note or debt is transferable or assumable upon satisfaction of guidelines or conditions specified by the lender or upon other subsequent events.

In some embodiments, the effective rate of the original borrower's mortgage becomes the new base rate that is subject to adjustment according to the invention herein. In other embodiments, the effective rate is adjusted, as discussed herein, to an interest rate that is within a specified range of a defined number to yield a new base rate. In some embodiments the assumption fee will take the form of an increase in the base rate and in other embodiments the assumption fee will take the form of a one-time fee. The new base rate can also be subject to adjustment, through the characteristics of the proposed or subsequent borrower and/or the transaction characteristics of the proposed or subsequent purchase and/or the assumption fee, as described herein, thereby yielding a new effective rate. It should be understood by those of skill in the art that the term LLPA refers to adjustments attributable, driven by or related to the characteristics of the proposed or subsequent borrower and/or the transaction characteristics of the proposed or subsequent purchase. Accordingly, the adjustment to the original effective rate is before any of the adjustments to the rate for the personal borrower and transactional characteristics as described herein. In other embodiments, the pricing methodology comprises the base mortgage rate. In other embodiments, the base mortgage rate is the rate represented in the primary origination on the existing financial obligation. In other embodiments, the base mortgage rate is the rate represented in the existing financial contract, note or debt instrument. In other embodiments, the base mortgage rate is the rate that is in effect at the time of the transfer or assumption. In other embodiments, the rate includes the original advertised, or market rate, plus any pricing adjustments. In other embodiments, the rate includes a fee resulting from the transfer or assumption of the existing obligation by the prospective borrower. In other embodiments, the fee resulting from the transfer or assumption of the existing obligation is an increase in interest rate rather than a fee due upon the original closing. In other embodiments, the rate comprises the net adjustments from the pricing adjustments, for example, the rates as established or required by a third party such as Fannie Mae or other government service entity. It is contemplated by the methodologies and the products of the invention that the adjustment of the interest rate of the mortgage as described herein can be affected in a variety of ways. The original effective rate of the existing borrower of a subject mortgage of the invention is the rate being paid by the existing borrower at the time of the assumption. In certain embodiments, where the original effective rate is adjusted upon the assumption as described herein, the adjusted original effective rate becomes the prospective or subsequent borrower's base rate. In certain embodiment, where there is no adjustment to the original effective rate upon assumption, the original effective rate becomes the prospective or subsequent borrower's base rate upon assumption. In some embodiments, the base rate can be adjusted and a fee is assessed in the event of an assumption. In other embodiments, the base rate is adjusted based on the characteristics of the proposed or subsequent borrower and/or the transaction characteristics of the proposed or subsequent purchase.

The methodologies and products of the invention also provide mortgages wherein fees or LLPAs are assessed as a consequence of an assumption. In some embodiments, fees and/or LLPAs are assessed as a consequence of an assumption. The subsequent effective rate of the assumed mortgage is equal to the base rate as defined above plus any adjustment due to fees or LLPAs where applicable. LLPAs and assumption fees, where applicable, can act as an adjustment on the base rate or may be structured as a one-time fee. Where the LLPAs and assumptions fees are structured as a one-time fee, the base rate of the assumed mortgage is the same as the subsequent effective rate. It is a feature of the invention that, in some embodiment, the adjustment in interest rates attributable to LLPAs and or fees may be directed or earmarked to any entity or person.

The methodologies, systems and products of the invention provide a number of benefits to all of the parties involved in a real estate transaction. For example, the invention provides a number of benefits to the insurer of the mortgage where the mortgage is insured. Moreover, where the mortgage is a component or part of a wrapped security, the methodologies or products of the invention provides a number of benefits to the entity that has wrapped the security. Where the mortgage or security is neither insured nor wrapped, the methodologies or products of the invention provide benefits to the investor that owns or otherwise holds the note. For purposes of the invention, the terms wrapped, insured and guaranteed can be used interchangeably. One of skill in the art would be familiar with the entities that wrap securities, such as Fannie Mae or other government sponsored entities or GSEs. One of skill in the art would also be familiar with the various benefits provided for by the methodologies and products of the invention, including pricing adjustments at the time of the original loan as well as at the time of the transfer or assumption. The entity that wraps the security or other GSE can also be compensated for any increase in risk to the whole loan and also assured that the risk adjusted value of the loan can only improve or remain the same. This same positive risk-adjustment mechanism will also makes the methodology of the invention attractive to private mortgage insurers. The features that limit the length of time during which and/or the number of times a loan can be assumed, and the features that specify the range of interest rates available upon assumption mitigate a lender's or investor's extension risk. The purchaser that assumes the existing obligation benefits through division of the cost of the transfer and assumption feature by fees that are allocated to the existing borrower and the purchaser respectively.

1. A mortgage product for mitigating and/or compensating for extension risk comprising:
a. maintaining an original real estate financing contract with an existing borrower, which contract is for a loan for a principal amount and secured by a mortgage on residential real estate held by the first borrower;
b. said contract providing for the assumption of the loan by a subsequent borrower;
c. said contract providing for a fee that is due as a result of said assumption; and
d. wherein said fee is intended to compensate for perceived extension risk associated with the assumption.

2. The mortgage product of claim 1, wherein the contract is assumable a defined number of times.

3. The mortgage product of claim 2, wherein the defined number of times is an integer selected from the group consisting of: 1-30.

4. The mortgage product of claim 1, wherein the contract is assumable only during a specified period of time.

5. The mortgage product of claim 4, wherein the specified period of time is between one day and thirty years.

6. A method of mitigating and/or compensating for extension risk associated with a real estate mortgage comprising:
a. maintaining an original real estate financing contract with an existing borrower, which contract is for a loan for a principal amount and secured by a mortgage on residential real estate held by the first borrower;
b. said contract providing for the assumption of the loan by a subsequent borrower;
c. engaging in a transaction wherein the subsequent borrower assumes the responsibilities of the existing borrower for said real estate financing contract;
d. imposing a fee as a result of the transaction; and
e. wherein said fee is intended to compensate for perceived extension risk associated with the assumption.

7. The method of claim 6, wherein the contract is assumable a defined number of times.

8. The method of claim 7, wherein the defined number of times is an integer selected from the group consisting of: 1-30.

9. The method of claim 6, wherein the contract is assumable only during a specified period of time.

10. A mortgage product for mitigating and/or compensating for extension risk comprising:
a. maintaining an original real estate financing contract with an existing borrower, which contract specifies a first interest rate for a loan for a principal amount that is secured by a mortgage on residential real estate held by the existing borrower;
b. said contract providing for the assumability of the loan by a subsequent borrower;
c. said contract providing for a different interest rate as a result of said assumption; and
d. said different interest rate intended to compensate for perceived extension risk associated with the assumption.

11. The mortgage product of claim 10, wherein the different interest is within a range of a defined number.

12. The mortgage product of claim 11, wherein the specified range is within one percentage point of an interest rate specified in the contract.

13. The mortgage product of claim 11, wherein the specified range is within one tenth of one percentage point to thirty percentage points of an interest rate specified in the contract.

14. The mortgage product of claim 11, wherein the contract is assumable one time.

15. The mortgage product of claim 11, wherein the contract is assumable during a specified period of time.

16. The mortgage product of claim 11, wherein the specified period of time is at most one year from the effective date of the contract.

17. The mortgage product of claim 10, wherein the contract is assumable at least one time.

18. The mortgage product of claim 10, wherein the contract is assumable during a specified period of time.

19. The mortgage product of claim 10, wherein the specified period of time is at most one year from the effective date of the contract.

20. The mortgage product of claim 10, wherein the contract is assumable at least one time.

21. The mortgage product of claim 1, wherein said fee compensates an investor.

22. The method of claim 6, wherein said fee compensates an investor.

23. The mortgage product of claim 10, wherein said differential between said first interest rate and said different interest rate compensates an investor.

24. The mortgage product of claim 4 wherein the contract is assumable a defined number of times.

25. The mortgage product of claim 15, wherein the contract is assumable a defined number of times.

26. A mortgage product for mitigating and/or compensating for extension risk comprising:
a. maintaining an original real estate financing contract with an existing borrower, which contract is for a loan for a principal amount and secured by a mortgage on residential real estate held by the first borrower;
b. said contract providing for the assumption of the loan by a subsequent borrower;
c. wherein said contract is assumable during a specified period of time.

27. A mortgage product for mitigating and/or compensating for extension risk comprising:
a. maintaining an original real estate financing contract with an existing borrower, which contract is for a loan for a principal amount and secured by a mortgage on residential real estate held by the first borrower;
b. said contract providing for the assumption of the loan by a subsequent borrower;
c. wherein said contract is assumable a defined number of times.

28. The mortgage product of claim 1, wherein the mortgage is securitized.

29. The mortgage product of claim 1, wherein the mortgage is wrapped.

30. The mortgage product of claim 1, wherein the mortgage is insured.

31. The method of claim 6, wherein the mortgage is securitized.

32. The method of claim 6, wherein the mortgage is wrapped.

33. The method of claim 6, wherein the mortgage is insured.

34. The mortgage product of claim 10, wherein the mortgage is securitized.

35. The mortgage product of claim 10, wherein the mortgage is wrapped.

36. The mortgage product of claim 10, wherein the mortgage is insured.

37. The mortgage product of claim 26, wherein the mortgage is securitized.

38. The mortgage product of claim 26, wherein the mortgage is wrapped.

39. The mortgage product of claim 26, wherein the mortgage is insured.

40. The mortgage product of claim 27, wherein the mortgage is securitized.

41. The mortgage product of claim 27, wherein the mortgage is wrapped.

42. The mortgage product of claim 27, wherein the mortgage is insured.

43. A data processing system implemented method for originating a mortgage product for mitigating and/or compensating for extension risk comprising:
a. maintaining an original real estate financing contract with an existing borrower, with the data processing system, which contract is for a loan for a principal amount and secured by a mortgage on residential real estate held by the first borrower;
b. said contract providing for the assumption of the loan by a subsequent borrower;
c. said contract providing for a fee that is due as a result of said assumption; and
d. wherein said fee is intended to compensate for perceived extension risk associated with the assumption.

44. A data processing system implemented method for mitigating and/or compensating for extension risk associated with a real estate mortgage comprising:
a. maintaining an original real estate financing contract with an existing borrower, with the data processing system, which contract is for a loan for a principal amount and secured by a mortgage on residential real estate held by the first borrower;
b. said contract providing for the assumption of the loan by a subsequent borrower;
c. engaging in a transaction wherein the subsequent borrower assumes the responsibilities of the existing borrower for said real estate financing contract;
d. imposing a fee as a result of the transaction; and
e. wherein said fee is intended to compensate for perceived extension risk associated with the assumption.

45. A data processing system implemented method for originating a mortgage product for mitigating and/or compensating for extension risk comprising:
a. maintaining an original real estate financing contract with an existing borrower, with the data processing system, which contract specifies a first interest rate for a loan for a principal amount that is secured by a mortgage on residential real estate held by the existing borrower;
b. said contract providing for the assumability of the loan by a subsequent borrower;
c. said contract providing for a different interest rate as a result of said assumption; and
d. said different interest rate intended to compensate for perceived extension risk associated with the assumption.

46. A data processing system implemented method of originating a mortgage product for mitigating and/or compensating for extension risk comprising:
d. maintaining an original real estate financing contract with an existing borrower, with the data processing system, which contract is for a loan for a principal amount and secured by a mortgage on residential real estate held by the first borrower;
e. said contract providing for the assumption of the loan by a subsequent borrower;
f. wherein said contract is assumable during a specified period of time.

47. A data processing system implemented method for originating a mortgage product for mitigating and/or compensating for extension risk comprising:
a. maintaining an original real estate financing contract with an existing borrower, with the data processing system, which contract is for a loan for a principal amount and secured by a mortgage on residential real estate held by the first borrower;
b. said contract providing for the assumption of the loan by a subsequent borrower;
c. wherein said contract is assumable a defined number of times.
